(19) United States
(12) Patent Application Publication
(10) Pub. No.: US 2022/0389295 A1
(43) Pub. Date: Dec. 8, 2022

(54) A CURABLE COMPOSITION AND A METHOD FOR ADHERING SUBSTRATES WITH THE SAME

(71) Applicant: Dow Global Technologies LLC, Midland, MI (US)

(72) Inventors: Zhengming Tang, Shanghai (CN); Yongchun Chen, Shanghai (CN); Xiuqing Xu, Shanghai (CN); Hongyu Chen, Zhangjiang (CN); Xuemei Zhai, Shanghai (CN); Ke Shi, Shanghai (CN); Nan Wang, Shanghai (CN); Qingwei Meng, Shanghai (CN)

(21) Appl. No.: 17/767,108

(22) PCT Filed: Nov. 15, 2019
(86) PCT No.: PCT/CN2019/118720

§ 371 Date: Apr. 7, 2022

(51) Int. Cl. C09J 183/14; C09J 163/00; C09J 183/04; C09J 7/10; C09J 11/08

(52) U.S. Cl. CPC C09J 183/14; C09J 163/00; C09J 183/04; C09J 7/10; C09J 11/08; C09J 2301/408

(57) ABSTRACT

Described is a curable composition, and particularly a two-component composition comprising a silane modified polymer; an epoxy resin terminated with epoxy terminal group; wherein the composition further comprises a hardening agent and a compatibilizer which has at least one silane group and at least one epoxy terminal group. The curable composition exhibits enhanced adhesion strength and good elongation at break. A method for applying the curable composition on the surface of a substrate is also provided.

### FIELD OF THE INVENTION

The present disclosure relates to a curable composition, particularly a two-component curable composition and a method for applying the same on the surface of a substrate. The curable composition exhibits enhanced adhesion strength and good elongation at break.

### BACKGROUND TECHNOLOGY

Silane-modified polymers (SMP), also known as silylated polymers, are versatile, high value industrial resins widely accepted for a large variety of applications. Silane modified polymer (SMP) based adhesives/sealants are gaining more and more popularity due to many advantages such as low VOC, iso-free and bubble-free, good balance of performance properties and durability, etc. Particularly speaking, the SMP based adhesives are superior over silicone based adhesives in that the former exhibits higher adhesion strength and can be overpainted with additional paint or coating material. Furthermore, the SMP based adhesives are superior over adhesives formulated with polyurethane prepolymers in the durability.

The SMP-based adhesives/sealants have been used in various applications including prefabricate construction (PC), home decoration, transportation [vehicle, vessel, automotive, aircraft and high speed railway (HSR)], industrial assembly and home appliance etc. Nevertheless, these applications usually require high adhesion strength, especially for transportation, industrial assembly and home appliance. For example, quite a few customers have been asking for SMP based adhesives with an adhesion strength higher than 5.0 MPa and elongation at break above 100-150%. Such high requirements on the mechanical strengths are generally considered as a huge challenge to the SMP based adhesives as most SMP based adhesives commercially sold in the market can only achieve an inferior adhesion strength around 3.0-4.0 MPa. Numerous efforts have been made by many researchers to modify factors such as fillers, resin ratio, adhesion promoters and catalysts, etc., but none of these researches of the prior art can achieve an adhesion strength as high as 5.0 MPa.

Without being limited to any specific theory, it is suspected that the inferior adhesion strength of the existing SMP based adhesive is at least partially due to the absence of any chemical linkage between the SMP phase and the other phase(s) used in combination with the same. An two component (2K) adhesive composition of the prior art is shown in FIG. 1, wherein the incorporation of various additives (such as hardening agent, catalyst, reaction accelerator, surfactant, etc.) and compatibilizer will establish little or no chemical linkage between the SMP phase and the epoxy phase, hence the resultant blend comprises chemically isolated SMP phase and an epoxy phase, thus exhibiting inferior cohesion and adhesion strength.

After persistent exploration, the inventors have surprisingly developed a two-component composition which can achieve one or more of the above targets. In particular, it was found that when a specific compatibilizer is included in the 2K curable composition of the present application, the adhesion strength can be further enhanced to a desirable level.

### SUMMARY OF THE INVENTION

The present disclosure provides a unique curable composition, particularly a curable two-component composition and a method for applying the curable composition on a surface of a substrate.

In a first aspect of the present disclosure, the present disclosure provides a curable composition, and particularly a two-component curable composition, comprising

at least one silane modified polymer;

at least one epoxy resin terminated with epoxy terminal group;

a hardening agent, and a compatibilizer which has at least one silane/siloxane group and at least one epoxy terminal group.

In a second aspect of the present disclosure, the present disclosure provides a method for applying said curable composition onto a surface of a substrate, comprising the steps of (1) combining the silane modified polymer, the epoxy resin, the hardening agent and the compatibilizer to form a precursor blend; (2) applying the precursor blend onto a surface of a substrate; and (3) curing the precursor blend, or allowing the precursor blend to cure.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic illustration of a 2K curable composition of the prior art;

FIG. 2 is a schematic illustration of an embodiment of the 2K curable composition described herein;

FIG. 3 shows the reaction mechanism of a hydrosilylation reaction for preparing the SMP according to an embodiment of the present disclosure.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. Unless indicated otherwise, all the percentages and ratios are calculated based on weight, and all the molecular weights are number average molecular weights.

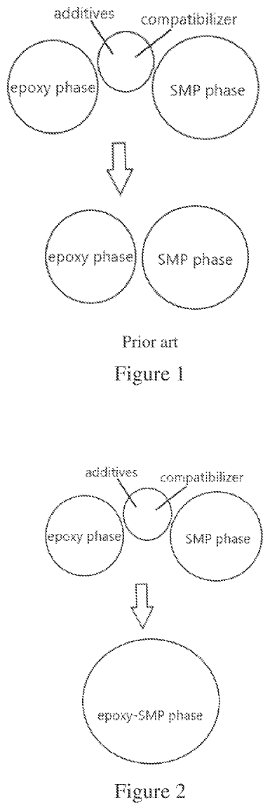

According to various embodiments of the present disclosure, the curable composition of the present disclosure is a “two-component”, “two-part” or “two-package” composition comprising component (A) which has a silane modified polymer and component (B) which has an epoxy resin. In the context of the present disclosure, the terms “part (A)”, “component (A)”, “silane modified polymer component (A)” and “silane modified polymer part (A)” can be used interchangeably and refer to the component in which the silane modified polymer is contained; the terms “part (B)”, “component (B)”, “epoxy resin part (B)” and “epoxy resin component (B)” can be used interchangeably and refer to the component in which the epoxy resin is contained. The component (A) and component (B) are transported and stored separately, combined shortly or immediately before being applied to the surface of a substrate. According to one embodiment of the present disclosure, the hardening agent and the compatibilizer are included in either one of component (A) and component (B). According to a preferable embodiment, the hardening agent is included in component (A), and the compatibilizer is included in component (B). Once combined, the reactive groups in each components, such as the epoxy terminal groups in the epoxy resin, the silane/siloxane groups in the SMP, the amine and imine groups in the hardening agent, the epoxy terminal groups/silane/siloxane groups contained in the compatibilizer, and any other reactive groups contained in the other additives or reactants, react with each other to establish a chemically integrated combination of SMP-epoxy resin. According to various embodiments of the present disclosure, once combined, the SMP phase is chemically linked with the epoxy resin via the hardening agent and the compatibilizer. Without being limited to any specific theory, an exemplary embodiment of the present disclosure is shown in FIG. 2. It shall be noted that although it is indicated in FIG. 2 that the SMP phase and the epoxy resin phase has been integrated into an epoxy-SMP phase, it does not mean that the molecules SMP and epoxy resin are linked by direct covalent bond, and it is hypothesized that the integration of the two phases can be achieved by the action (e.g. synergic action) of the hardening agent and the compatibilizer. The comparison between FIG. 1 and FIG. 2 clearly shows the difference between the chemically integrated combination of the present application and the chemically isolated system of the prior art. Without being limited to any specific theory, it is suspected that the incorporation of the particularly designed compatibilizer in the composition of the present disclosure can effectively achieve a chemically integrated combination of SMP-epoxy resin, thus successfully enhance the adhesion strength of the resultant composition to a level as high as 5.0 MPa while retaining a good elongation property thereof.

According to various embodiments of the present disclosure, the curable composition of the present disclosure is a two-component composition which can be an adhesive, sealant, coating or concrete, and is preferably a 2K adhesive or a 2K sealant. The curable composition of the present disclosure can be applied on the surface of a substrate to form a coating film, a concrete layer or a sealant layer thereof to achieve the functions of physical/chemical protection, sonic/thermal/irradiation barrier, filling material, supporting/carrying/construction structure, decorative layer or sealing/hermetic/waterproof layer. Besides, when the curable composition of the present disclosure is used as an adhesive, it can be used for adhering two or more identical or different substrates together. According to an embodiment of the present disclosure, the substrate is at least one member selected from the group consisting of metal, masonry, concrete, paper, cotton, fiberboard, paperboard, wood, woven or nonwoven fabrics, elastomers, polycarbonates, phenol resins, epoxy resins, polyesters, polyethylencarbonate, synthetic and natural rubber, silicon, and silicone polymers. According to another embodiment of the present disclosure, the substrate is a polymer substrate selected from the group consisting of polymethylmethacrylate, polypropylenecarbonate, polybutenecarbonate, polystyrene, acrylonitrile-butadiene-styrene resin, acrylic resin, polyvinyl chloride, polyvinyl alcohol, polycarbonates, polyethylene terephthalate, polyurethanes, polyimides, and copolymers thereof. According to another embodiment of the present disclosure, the substrate is selected from the group consisting of wood, polystyrene, nylon, and acrylonitrile-butadiene-styrene.

The Silane Modified Polymer (SMP)

According to various embodiments of the present disclosure, the component (A) is a component comprising a silane modified polymer. The SMP can be a polymer having silane groups. For examples, the SMP can be represented by formula I:

R¹ₘ(R²O)₍₃₋ₘ₎Si—R⁷-(polymeric main chain)-R⁸—SiR³ₙ(R⁴O)₍₃₋ₙ₎ Formula I

wherein the polymeric main chain is derived from a polyol, or derived from at least one polyisocyanate and at least one polyol, and is optionally functionalized with at least one —R⁹—SiR⁵ₛ(R⁶O)₍₃₋ₛ₎, each of R¹, R², R³, R⁴, R⁵ and R⁶ independently represents a hydrogen atom or a C₁-C₆ alkyl group, each of m, n and s represents an integrate of 0, 1 or 2, each of R⁷, R⁸ and R⁹ independently represents a direct bond, —O—, a divalent (C₁ to C₆ alkylene) group, —O—(C₁ to C₆ alkylene) group, (C₁ to C₆ alkylene)-O— group, —O—(C₁ to C₆ alkylene)-O— group, —N(R_{N})—(C₁ to C₆ alkylene) group or —C(═O)—N(R_{N})—(C₁ to C₆ alkylene) group, wherein R_{N} represents a hydrogen atom or a C₁-C₆ alkyl group.

According to an embodiment of the present disclosure, the polymeric main chain can be derived from a polyether polyol or a polyester polyol.

In the context of the present disclosure, the “silane modification” refers to the attachment of the groups “R¹ₘ(R²O)₍₃₋ₘ₎Si—R⁷—”, “—R⁸—SiR³ₙ(R⁴O)₍₃₋ₙ₎” and “—R⁹—SiR⁵ₛ(R⁶O)₍₃₋ₛ₎” to the polymeric main chain in the SMP, and all the above stated silicone-containing substitution groups (no matter the groups R¹—, R²O—, R³—, R⁴O—, R⁵— and R⁶O— actually refer to hydrogen, hydroxyl, alkyl or alkoxy groups) are collectively referred as “silane group”. The above stated “R¹ₘ(R²O)₍₃₋ₘ₎Si—R⁷—” and “—R⁸—SiR³ₙ(R⁴O)₍₃₋ₙ₎” represent terminal groups attached to the ends of the SMP, while the —R⁹—SiR⁵ₛ(R⁶O)₍₃₋ₛ₎ represents at least one side group attached to the intermediate repeating unit of the polymeric main chain.

In the context of the present disclosure, the C₁-C₆ alkyl group includes methyl, ethyl, n-propyl, i-propyl, n-butyl, i-butyl, sec-butyl, t-butyl, n-pentyl, i-pentyl, tert-pentyl, neo-pentyl and n-hexyl; the C₁ to C₆ alkylene includes methylene, ethylene, propylene, butylene, pentamethylene and hexamethylene.

According to an embodiment of the present disclosure, the polymeric main chain is derived from a polyol, and the SMP represented by formula I may be prepared by reacting at least one reactive capping group (e.g. allyl group etc.) attached to the polyol (i.e. the polymeric main chain) with a trialkoxysilane group through hydrosilylation reaction, or by reacting a polyisocyanate with a polyol to form a polyurethane intermediate, i.e. the polymeric main chain, which is then functionalized with a silanizing agent.

According to a preferable embodiment of the present disclosure, the polyurethane intermediate is a polyurethane chain having isocyanate terminal group, and the silanizing agent comprises a silane group on one end and an isocyanate-reactive group (such as hydroxyl or amine group) on the other end. In the context of the present disclosure, the amine group can be a primary or a secondary amine group.

According to another preferable embodiment of the present disclosure, the polyurethane intermediate is a polyurethane chain having a hydroxyl terminal group, and the silanizing agent comprises a silane group on one end and an isocyanate group on the other end.

In various embodiments, the polyisocyanate compound for preparing the polymeric main chain (polyurethane chain) is an aliphatic, cycloaliphatic, aromatic or heteroaryl compound having at least two isocyanate groups. In a preferable embodiment, the polyisocyanate compound can be selected from the group consisting of C₄-C₁₂ aliphatic polyisocyanates comprising at least two isocyanate groups, C₆-C₁₅ cycloaliphatic or aromatic polyisocyanates comprising at least two isocyanate groups, C₇-C₁₅ araliphatic polyisocyanates comprising at least two isocyanate groups, and combinations thereof. In another preferable embodiment, suitable polyisocyanate compounds include m-phenylene diisocyanate, 2,4-toluene diisocyanate and/or 2,6-toluene diisocyanate (TDI), the various isomers of diphenylmethanediisocyanate (MDI), carbodiimide modified MDI products, hexamethylene-1,6-diisocyanate, tetramethylene-1,4-diisocyanate, cyclohexane-1,4-diisocyanate, hexahydrotoluene diisocyanate, hydrogenated MDI, naphthylene-1,5-diisocyanate, isophorone diisocyanate (IPDI), or mixtures thereof. Generally, the amount of the polyisocyanate compound may vary based on the actual requirement of the SMP and the resultant curable composition. For example, as one illustrative embodiment, the content of the polyisocyanate compound can be from 15 wt % to 60 wt %, or from 20 wt % to 50 wt %, or from 23 wt % to 40 wt %, or from 25 wt % to 38 wt %, based on the total weight of the SMP.

According to one embodiment of the present disclosure, the polyol for the polymeric main chain or for preparing the polyurethane main chain can be selected from the group consisting of C₂-C₁₆ aliphatic polyhydric alcohols comprising at least two hydroxyl groups, C₆-C₁₅ cycloaliphatic or aromatic polyhydric alcohols comprising at least two hydroxyl groups, C₇-C₁₅ araliphatic polyhydric alcohols comprising at least two hydroxyl groups, polyester polyols having a molecular weight from 100 to 5,000 and an average hydroxyl functionality of 1.5 to 5.0, a polyether polyol which is a poly(C₂-C₁₀)alkylene glycol or a copolymer of multiple (C₂-C₁₀)alkylene glycols having a molecular weight from 100 to 5,000, polycarbonate diols having a molecular weight from 100 to 5,000, and combinations thereof; and additional comonomers selected from the group consisting of C₂ to C₁₀ polyamine comprising at least two amino groups, C₂ to C₁₀ polythiol comprising at least two thiol groups and C₂-C₁₀ alkanolamine comprising at least one hydroxyl group and at least one amino groups, can also be used. According to a preferable embodiment, the polyol is a polyether polyol. In various embodiments, the polyether polyol used as the polyol has a molecular weight of 100 to 5,000 g/mol, and may have a molecular weight in the numerical range obtained by combining any two of the following end point values: 120, 150, 180, 200, 250, 300, 350, 400, 450, 500, 550, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900 and 5000 g/mol. In various embodiments, the polyether polyol has an average hydroxyl functionality of 1.5 to 5.0, and may have an average hydroxyl functionality in the numerical range obtained by combining any two of the following end point values: 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9 and 5.0. According to one preferable embodiment, the polyol has an average kinematic viscosity of 500 to 1,200 cSt, or from 600 to 1,100 cSt, or from 700 to 1,000 cSt, or from 800 to 950 cSt, or from 850 to 920 cSt; and has an OH number of 10 to 100 mg KOH/g, or from 12 to 90 mg KOH/g, or from 15 to 80 mg KOH/g, or from 16 to 70 mg KOH/g, or from 17 to 60 mg KOH/g, or from 18 to 50 mg KOH/g, or from 19 to 40 mg KOH/g, or from 20 to 30 mg KOH/g, or from 25 to 28 mg KOH/g. According to a preferable embodiment of the present disclosure, the polyether polyol is selected from the group consisting of polyethylene glycol, polypropylene glycol, polytetramethylene glycol, poly(2-methyl-1,3-propane glycol) and any copolymers thereof, such as poly(ethylene oxide-propylene oxide) glycol. According to another preferable embodiment of the present disclosure, the polyether polyol may comprise at least one poly(C₂-C₁₀)alkylene glycol or copolymer thereof, for example, the polyether polyol may be selected from the group consisting of (methoxy)polyethylene glycol (MPEG), polyethylene glycol (PEG), poly(propylene glycol), polytetramethylene glycol, poly(2-methyl-1,3-propane glycol) or copolymer of ethylene epoxide and propylene epoxide (polyethylene glycol-propylene glycol) with primary hydroxyl ended group or secondary hydroxyl ended group.

According to an embodiment of the present disclosure, the polyether polyols can be prepared by polymerization of one or more linear or cyclic alkylene oxides selected from propylene oxide (PO), ethylene oxide (EO), butylene oxide, tetrahyfrofuran, 2-methyl-1,3-propane glycol and mixtures thereof, with proper starter molecules in the presence of a catalyst. Typical starter molecules include compounds having at least 1, preferably from 1.5 to 3.0 hydroxyl groups or having one or more primary amine groups in the molecule. Suitable starter molecules having at least 1 and preferably from 1.5 to 3.0 hydroxyl groups in the molecules are for example selected from the group comprising ethylene glycol, 1,2-propanediol, 1,3-propanediol, 1,2-butanediol, 1,3-butanediol, 1,4-butenediol, 1,4-butynediol, 1,5-pentanediol, neopentyl glycol, 1,4-bis(hydroxymethyl)-cyclohexane, 1,2-bis(hydroxymethyl)cyclohexane, 1,3-bis(hydroxymethyl)-cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, trimethylolpropane, glycerol, pentaerythritol, castor oil, sugar compounds such as, for example, glucose, sorbitol, mannitol and sucrose, polyhydric phenols, resols, such as oligomeric condensation products of phenol and formaldehyde and Mannich condensates of phenols, formaldehyde and dialkanolamines, and also melamine Starter molecules having one or more primary amine groups in the molecules may be selected for example from the group consisting of aniline, EDA, TDA, MDA and PMDA, more preferably from the group comprising TDA and PMDA, an most preferably TDA. When TDA is used, all isomers can be used alone or in any desired mixtures. For example, 2,4-TDA, 2,6-TDA, mixtures of 2,4-TDA and 2,6-TDA, 2,3-TDA, 3,4-TDA, mixtures of 3,4-TDA and 2,3-TDA, and also mixtures of all the above isomers can be used. Catalysts for the preparation of polyether polyols may include alkaline catalysts, such as potassium hydroxide, for anionic polymerization or Lewis acid catalysts, such as boron trifluoride, for cationic polymerization. Suitable polymerization catalysts may include potassium hydroxide, cesium hydroxide, boron trifluoride, or a double cyanide complex (DMC) catalyst such as zinc hexacyanocobaltate or quaternary phosphazenium compound. In a preferable embodiment of the present disclosure, the starting material polyether polyol includes polyethylene, (methoxy)polyethylene glycol (MPEG), polyethylene glycol (PEG), poly(propylene glycol), polytetramethylene glycol, poly(2-methyl-1,3-propane glycol) or copolymer of ethylene epoxide and propylene epoxide (polyethylene glycol-propylene glycol) with primary hydroxyl ended group or secondary hydroxyl ended group.

According to a preferable embodiment of the present disclosure, the amount of the polyisocyanate is properly selected so that the isocyanate group is present at a stoichiometric molar amount relative to the total molar amount of the hydroxyl groups included in the polyol and any additional additives or modifiers. According to an embodiment of the present disclosure, the polyurethane intermediate (PU main chain) has a NCO content of from 2 to 50 wt %, preferably from 6 to 49 wt %, preferably from 8 to 25 wt %, preferably from 10 to 20 wt %, more preferably from 11 to 15 wt %, most preferably from 12 to 13 wt %.

The reaction between the polyisocyanate and the polyol may occur in the presence of one or more catalysts that can promote the reaction between the isocyanate group and the hydroxyl group. Without being limited to theory, the catalysts can include, for example, glycine salts; tertiary amines; tertiary phosphines, such as trialkylphosphines and dialkylbenzylphosphines; morpholine derivatives; piperazine derivatives; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin(II) salts of organic carboxylic acids, e.g., tin(II) diacetate, tin(II) dioctanoate, tin(II) diethylhexanoate, and tin(II) dilaurate, and dialkyltin(IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt; or mixtures thereof. In general, the content of the catalyst used herein is larger than zero and is at most 3.0 wt %, preferably at most 2.5 wt %, more preferably at most 2.0 wt %, based on the total weight of the component (A).

The silanizing agent used for introducing the silane group (especially, “R¹ₘ(R²O)₍₃₋ₘ₎Si—R⁷—”, “—R⁸—SiR³n(R⁴O)₍₃₋ₙ₎” and “—R⁹—SiR⁵ₛ(R⁶O)₍₃₋ₛ)”) into the SMP can be represented by a formula of silane-X, where the X group may be hydrogen, hydroxyl, amine group, imine group, isocyanate group, halogen atom (e.g. chlorine, bromine or iodine), ketoximato, amino, amido, acid amide, aminoxy, mercapto or alkenyloxy groups. Examples of suitable silanizing agent include γ-aminopropylmethyldimethoxysilane, γ-aminopropylmethyldiethoxysilane, γ-aminopropyltrimethoxysilane, γ-aminopropyltriethoxysilane, γ-aminophenyltrimethoxysilane, aminoethylaminopropyltrimethoxysilane, aminoethylaminopropyltriethoxysilane, aminoethyl aminoethylaminopropyltrimethoxysilane, aminoethylaminomethylmethyldiethoxysilane, (3-aminopropyl)-diethoxy-methylsilane, (3-aminopropyl)-dimethyl-ethoxysilane, (3-aminopropyl)-trimethoxysilane, N-((β-aminoethyl)-γ-aminopropyltriethoxysilane, γ-aminopropyldimethylmethoxysilane, N-((β-aminoethyl)-γ-aminopropyltrimethoxysilane, N-phenyl-γ-aminopropyltrimethoxysilane, (aminoethylaminomethyl)phenethyltrimethoxysilane, N-((β-aminoethyl)-γ-aminopropylmethyldimethoxysilane, N-(6-aminohexyl)-3-aminopropyl trimethoxysilane, N-(2-aminoethyl)-11-aminoundecyltrimethoxysilane, N-((β-aminoethyl)-γ-aminopropylethyldiethoxylsilane, and mixtures thereof.

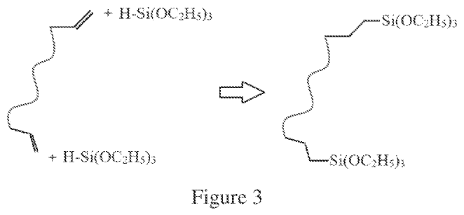

According to a preferable embodiment of the present disclosure, the polymeric main chain is solely derived from a polyol, and is preferably a polyether polyol or a polyester polyol. The polymeric main chain can be encapped with two or more terminal groups such as hydroxyl group, glycidyl group, allyl group, or combination thereof. A hydrosilylation reaction may occurs between the above stated terminal group of the polyol chain and the X group of the silanizing agent to form the SMP. The mechanical scheme of the hydrosilylation reaction is shown in FIG. 3, in which the silanizing agent is SiH(OC₂H₅)₃.

According to another preferable embodiment of the present disclosure, the polymeric main chain is a polyurethane main chain derived from the reaction of the polyisocyanate and the polyol. The polymeric main chain can be encapped with two or more terminal groups such as hydroxyl group or isocyanate group. A silylation reaction may occurs between the above stated terminal group of the polyurethane main chain and the X group of the silanizing agent to form the SMP.

According to one embodiment of the present disclosure, the molar content of the silanizing agent is selected such that the SMP has a silane functionality of 1.2 to 4.0, preferably from 1.5 to 3.0, more preferably from 1.8 to 2.5, and more preferably from 2.0 to 2.2.

Generally, the amount of the SMP may vary based on the actual requirement of the resultant curable composition. For example, as one illustrative embodiment, the content of the SMP can be from 10 wt % to 90 wt %, or from 10 wt % to 85 wt %, or from 10 wt % to 80 wt %, or from 10 wt % to 75 wt %, or from 10 wt % to 70 wt %, or from 10 wt % to 65 wt %, or from 20 to 65 wt %, or from 20 wt % to 60 wt %, or from 12 wt % to 50 wt %, or from 14 wt % to 40 wt %, or from 15 wt % to 30 wt %, or from 17 wt % to 25 wt %, or from 18 wt % to 22 wt %, based on the total weight of the curable composition.

The Epoxy Resin

In various embodiments of the present disclosure, the component (B) comprises an epoxy resin having at least one, preferably two epoxy terminal groups.

The epoxy resin can be any polymeric material containing epoxy functionality. The compound containing reactive epoxy functionality can vary widely, and it includes polymers containing epoxy functionality or a blend of two or more epoxy resins. The epoxy resin can be saturated or unsaturated, aliphatic, cycloaliphatic, aromatic or heterocyclic and can be substituted. In some embodiments, the epoxy resin can include a polyepoxide. Polyepoxide refers to a compound or mixture of compounds containing more than one epoxy moiety. Polyepoxides include partially advanced epoxy resins that is, the reaction product of a polyepoxide and a chain extender, wherein the reaction product has, on average, more than one unreacted epoxide unit per molecule. Aliphatic polyepoxides may be prepared from the reaction of epihalohydrins and polyglycols. Other specific examples of aliphatic epoxides include trimethylpropane epoxide, and diglycidyl-1,2-cyclohexane dicarboxylate. Other compounds include, epoxy resins such as, for example, the glycidyl ethers of polyhydric phenols (that is, compounds having an average of more than one aromatic hydroxyl group per molecule).

In one embodiment, the epoxy resins utilized in the curable composition of the present disclosure include those resins produced from an epihalohydrin and a phenol or a phenol type compound. The phenol type compound includes compounds having an average of more than one aromatic hydroxyl group per molecule. Examples of phenol type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (which is the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof. Specifically, phenol type compounds include resorcinol, catechol, hydroquinone, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, cresol-hydroxybenzaldehyde resins, dicyclopentadiene-phenol resins, dicyclopentadiene-substituted phenol resins, tetramethylbiphenol, tetramethyl-tetrabromobiphenol, tetramethyltribromobiphenol, and tetrachlorobisphenol A. In some embodiments the epoxy resins of the present compositions can have a functionality of at least 1.5, at least 3, or even at least 6.

In some embodiments, the epoxy resins utilized in the epoxy component (B) include those resins produced from an epihalohydrin and an amine Suitable amines include diaminodiphenylmethane, aminophenol, xylene diamine, anilines, or combinations thereof.

In some embodiments, the epoxy resins utilized in the epoxy component include those resins produced from an epihalohydrin and a carboxylic acid. Suitable carboxylic acids include phthalic acid, isophthalic acid, terephthalic acid, tetrahydro- and/or hexahydrophthalic acid, endomethylenetetrahydrophthalic acid, isophthalic acid, methylhexahydrophthalic acid, or combinations thereof.

In some embodiments the epoxy resin is an advanced epoxy resin which is the reaction product of one or more epoxy resins, as described above, with one or more phenol type compounds and/or one or more compounds having an average of more than one aliphatic hydroxyl group per molecule. Alternatively, the epoxy resin may react with a carboxyl substituted hydrocarbon, which is a compound having a hydrocarbon backbone, preferably a C₁-C₄₀ hydrocarbon backbone, and one or more carboxyl moieties, preferably more than one, and most preferably two. The C₁-C₄₀ hydrocarbon backbone can be a straight- or branched-chain alkane or alkene, optionally containing oxygen. Fatty acids and fatty acid dimers are among the useful carboxylic acid substituted hydrocarbons. Included in the fatty acids are caproic acid, caprylic acid, capric acid, octanoic acid, decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In some embodiments, the epoxy resin is the reaction product of a polyepoxide and a compound containing more than one isocyanate moiety or a polyisocyanate. For example, the epoxy resin produced in such a reaction can be an epoxy-terminated polyoxazolidone.

In one specific embodiment, the epoxy resin component is a blend of a brominated epoxy resin and a phenolic novolac epoxy resin.

According to various embodiments of the present application, the epoxy resin has a molecular weight of 100 to 20,000 grams per mole (g/mol), or from 500 to 15,000 g/mol, or from 800 to 12,000 g/mol, or from 1,000 to 10,000 g/mol, or from 2,000 to 9,000 g/mol, or from 3,000 to 8,000 g/mol, or from 4,000 to 7,000 g/mol, or from 5,000 to 6,000 g/mol. According to various embodiments of the present application, the epoxy resin has an epoxy functionality of 1.2 to 10, or from 2 to 9, or from 3 to 8, or from 4 to 7, or from 5 to 6. Generally, the amount of the epoxy resin may vary based on the actual requirement of the resultant curable composition. For example, as one illustrative embodiment, the content of the epoxy resin can be from 5 wt % to 70 wt %, or from 7 wt % to 68 wt %, or 5 wt % to 65 wt %, or 10 wt % to 65 wt %, or from 11 wt % to 60 wt %, or from 12 wt % to 50 wt %, or from 14 to 40 wt %, or from 15 wt % to 30 wt %, or from 17 wt % to 25 wt %, or from 18 wt % to 22 wt %, based on the total weight of the curable composition.

Hardening Agent

According to various embodiments of the present disclosure, the hardening agent that can be used in the practice of this disclosure includes aliphatic amines, alicyclic amines, aromatic amines, polyaminoamides, imidazoles, dicyandiamides, epoxy-modified amines, Mannich-modified amines, Michael addition-modified amines, ketimines, acid anhydrides, alcohols and phenols, among others. According to a most preferable embodiment of the present application, the hardening agent is triethylene tetramine (TETA). As one illustrative embodiment, the content of the hardening agent is from 1 wt % to 8 wt %, or from 1 wt % to 5 wt %, or from 1.5 wt % to 4 wt %, or from 1.8 wt % to 3 wt %, or from 1.9 to 2.5 wt %, or from 2 wt % to 2.2 wt %, based on the total weight of the curable composition. The hardening agent can be either supplied and transmitted as an component independent from the component A and B, or contained in component A or B. According to a preferable embodiment of the present disclosure, the hardening agent is contained in component A, i.e. as a blend with the SMP.

Compatibilizer

The compatibilizer useful for the curable composition of the present disclosure is particularly characterized in that it comprises both the silane group as stated above and the epoxy group.

According to an embodiment of the present disclosure, the compatibilizer is represented by formula II, or can be a condensation oligomer or condensation polymer thereof:

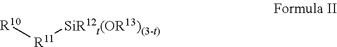

wherein R¹⁰ is selected a group consisting of

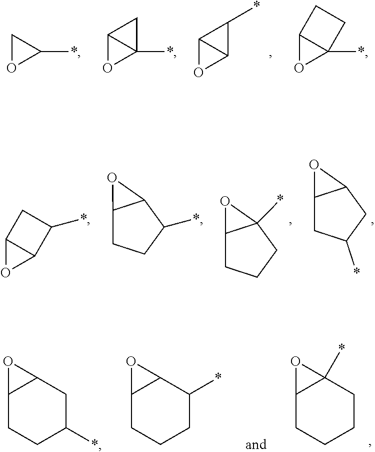

wherein * represents the linkage site where R¹⁰ is linked to the other moiety of the compatibilizer,

R¹¹ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ-C₂-C₆ alkylene-(O—CH₂)—CH(OH)—CH₂—NH—C₂-C₆ alkylene, and —(CH₂—O)—C₂-C₆ alkylene-Si(C₁-C₆ alkoxy)₂[O—Si(C₁-C₆ alkoxy)₂]ₓ-C₂-C₆ alkylene-(O—CH₂)—CH(OH)—CH₂—NH—C₂-C₆ alkylene,

wherein each of R¹² and R¹³ independently represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₄, —Si(C₁-C₄ alkoxy)₃, —Si—{O—[Si(C₁-C₄alkoxy)₄]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃,

t represents an integer of 0, 1 or 2, and x represents an integer of 1 to 100. For example, x can be an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100.

As indicated herein, the term “condensation oligomer” and “condensation polymer” refers to an oligomeric or polymeric compound obtained by condensing two or more compound represented by Formula II, and especially via the condensation of silane group. For example, the compatibilizer can be a condensation oligomer or condensation polymer represented by formula III,

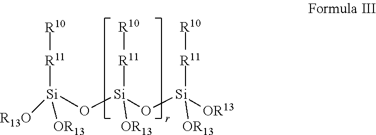

wherein R¹⁰, R¹¹ and R¹³ are as stated above, and r represents an integer of 1 to 50, such as an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50.

According to a most preferable embodiment of the present disclosure, the compatibilizer is selected from any one of the following compounds:

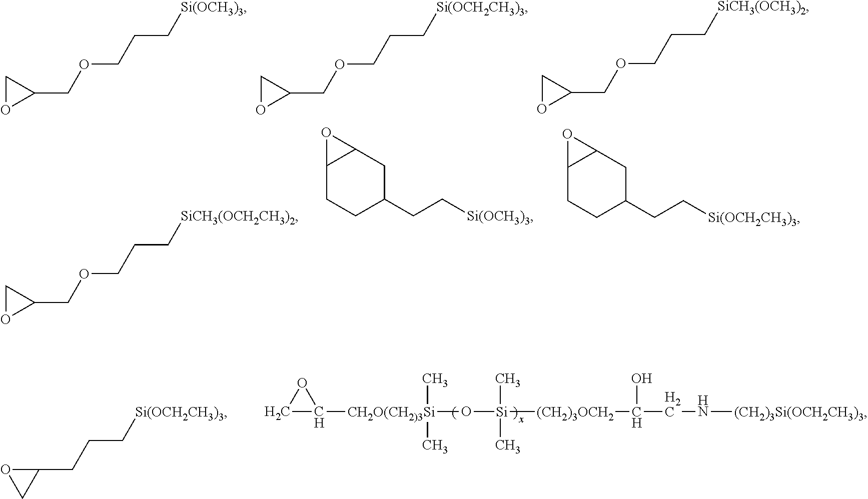

wherein x represents an integer of 1 to 100, such as an integer of an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100,

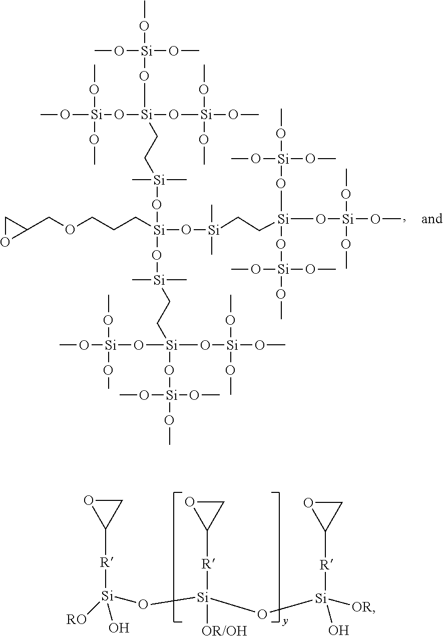

wherein R′ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-[O—Si(C₁-C₆alkoxy)₂]ₓ-C₂-C₆ alkylene-(O—CH₂)—CH(OH)—CH₂—NH—C₂-C₆ alkylene, R represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃, and y represents an integer of 1 to 50, such as an integer of 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49 or 50.

As one illustrative embodiment, the content of the compatibilizer is from 1 wt % to 20 wt %, or from 1 wt % to 15 wt %, or from 1.5 wt % to 14 wt %, or from 1.8 wt % to 13 wt %, or from 2 to 12 wt %, or from 3 wt % to 11 wt %, or from 4 wt % to 10 wt %, or from 5 wt % to 9 wt %, or from 6 wt % to 8 wt %, or from 6.5 wt % to 7 wt %, based on the total weight of the curable composition. The compatibilizer can be either supplied and transmitted as a component independent from the component A and B, or contained in component A or B. According to a preferable embodiment of the present disclosure, the hardening agent is contained in component B, i.e. as a blend with the epoxy resin.

According to preferable embodiments of the present disclosure, the amounts of the SMP, the epoxy resin, the hardening agent and the compatibilizer are particularly selected so that the molar ratio of total epoxy functionality to total amine functionality could be in the range of 1:0.95 to 0.95:1; the molar ratio of the epoxysilane compatibilizer to the epoxy resin is from 1:10 to 1:1; and the molar ratio of total epoxy group (including the epoxy group in the epoxy resin and compatibilizer) to total SMP resins could be from 1:100 to 5:1.

Additives In various embodiments of the present disclosure, the curable composition may further comprises one or more additives selected from the group consisting of catalyst; moisture scavengers, such as vinyl-Si[O—(C₁-C₄)alkyl]; chain extenders; crosslinkers; tackifiers; plasticizers, such as phthalic acid esters, non-aromatic dibasic acid esters and phosphoric esters, polyesters of dibasic acids with a dihydric alcohol, polypropylene glycol and its derivatives, polystyrene; rheology modifiers; antioxidants; fillers, such as calcium carbonate, kaolin, talc, silica, titanium dioxide, aluminum silicate, magnesium oxide, zinc oxide and carbon black; colorants; pigments; surfactants; solvents, such as hydrocarbons, acetic acid esters, alcohols, ethers and ketones; diluents; flame retardants; slippery-resistance agents; antistatic agents; preservatives; biocides; UV stabilizers; thixotropes; anti-sagging agents, such as hydrogenated castor oil, organic bentonite, calcium stearate; and combinations of two or more thereof. These additives are used in known ways and amounts. These additives can be transmitted and stored as independent components and incorporated into the polyurethane composition shortly or immediately before the combination of components (A) and (B). Alternatively, these additives may be contained in either of components (A) and (B) when they are chemically inert to the reactive groups such as epoxy group, amino group and silane group.

The above stated catalyst refers to a catalytic substance which may further accelerate or enhance the interaction between the reactive groups such as epoxy group, amino group and silane group. It is also known as curing catalyst and can be used each independently or in a combination of two or more species. Representative catalysts include dibutyltin dilaurate, dibutyltin acetoacetate, titanium acetoacetate, titanium ethyl acetoacetate complex and tetraisopropyl titanate, bismuth carboxylate, zinc octoate, blocked tertiary amines, zirconium complexes, and combinations of amine and Lewis acid catalysts adducts of tin compositions and silicic acid.

According a preferable embodiment of the present disclosure, the curable composition of the present disclosure does not comprise an aminosilane compound as stated above. According another preferable embodiment of the present disclosure, the curable composition of the present disclosure does not comprise a hydroxylsilane compound. According to various aspects of the present application, improvement in the adhesion strength has been successfully achieved while retaining the elongation ratio.

One combined, the silane modified polymer, epoxy resin, hardening agent and compatibilizer react with each other and gradually cure to form the target layer or structure. The curing process may be carried out, for example, under a temperature of 0° C. or higher, preferably 20° C. or higher, more preferably 60° C. or higher and most preferably 80° C. or higher, at the same time 300° C. or lower, preferably 250° C. or lower, more preferably 200° C. or lower and most preferably 180° C. or lower. The curing process may be carried out, for example, at a pressure of desirably 0.01 bar or higher, preferably 0.1 bar or higher, more preferably 0.5 bar or higher and at the same time desirably 1000 bar or lower, preferably 100 bar or lower, and more preferably 10 bar or lower. The curing process may be carried out for a predetermined period of time sufficient to cure the SMP-epoxy composition. For example, the curing time may be desirably one minute or more, preferably 10 minutes or more, more preferably between 100 minutes or more and at the same time may be desirably 24 hours or less, preferably 12 hours or less and more preferably 8 hours or less.

The uncured blend of the component A and component B may be applied to one or more substrates by a batch or a continuous process. The uncured blend may be applied by technologies such as gravity casting, vacuum casting, automatic pressure gelation (APG), vacuum pressure gelation (VPG), infusion, filament winding, injection (for example, lay up injection), transfer molding, prepreging, dipping, coating, potting, encapsulation, spraying, brushing, and the like.

### EXAMPLES

Some embodiments of the invention will now be described in the following Examples. However, the scope of the present disclosure is not, of course, limited to the formulations set forth in these examples. Rather, the Examples are merely an illustration of the disclosure.

The information of the raw materials used in the examples is listed in the following table 1:

TABLE 1
Raw materials used in the examples

| Product name | Structure | Function | Supplier |
|---|---|---|---|
| Voranol ™ 4000LM | Linear PO polyol (diol) | Polyol | Dow Chemical |
| IPDI | 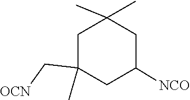 | Polyisocyanate | SCRC |
| D.E.R. ™ 383 | Bisphenol A epoxy resin | Epoxy resin | Dow Chemical |
| SCA-3303 | 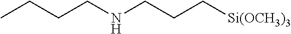 | Capping agent | Guotai Huarong |
| TETA | 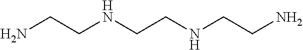 | Hardening agent | SCRC |
| DINP | 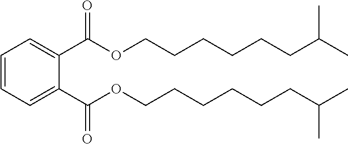 [SMILES: CC(C)CCCCCCOC(=O)c1ccccc1C(=O)OCCCCCCC(C)C] | Plasticizer | Exxon Mobil Corporation |
| KH560 | 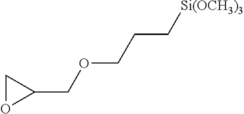 | Compatibilizer | Dow Chemical |
| XTCC-201 | Surface treated precipitated calcium carbonate | Reinforcing filler | Jiangxi Xintai Chemical |
| VTMS | 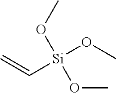 | Moisture scavenger | DOW Chemical |
| DMT | Dimethyltin dineodecanoate | Catalyst | SEHOTECH INC |
| T-12 | 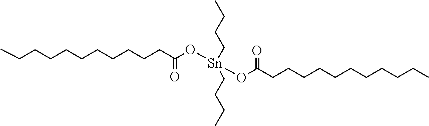 [SMILES: CCCCCCCCCCCC(=O)[O][Sn]([CH2]CCC)([CH2]CCC)[O]C(=O)CCCCCCCCCCC] | Catalyst | SEHOTECH INC |
| | T-12 | | |

### Preparation Example: Preparation of SMP

Voranol™ 4000 LM (4000 g) was added into a three neck flask with N₂ protection at room temperature, and heated at 110° C. for 4 hours under a nitrogen flow. The substance in the flask was cooled down to 80° C., then T12 (2.0 g) and IPDI (296.4 g) were added therein, and the flask was further heated at 80° C. for 4 hours. Then SCA-3303 (156.93) was added into the flask and the mixture was heated at 80° C. for 4 hours. After the reaction, the resultant SMP was transferred into a sealed bottle for further characterization, formulation and test.

### Comparative Examples 1 to 2 and Inventive Examples 3 to 8

Different two-component curable compositions were prepared according to the formulations listed in Table 2, wherein Examples 1 and 2 were comparative examples which did not comprise the compatibilizer particularly selected by the present disclosure, and the SMP resin was prepared in the above stated Preparation Example.

As can be seen from Table 2, Part A contains SMP resins, hardening agent and moisture scavenger, and optionally further comprises plasticizers and fillers; and Part B contains epoxy resins, epoxysilanes compatibilisers and tin catalyst. Part A and Part B were prepared separately by mixing the ingredients thereof in separate speed mixers under a stirring rate of 2,000 rpm/min The Part A and Part B were combined and mixed thoroughly in a speed mixer under a stiffing speed of 1,000 rpm/min for 20 seconds, under 1,500 rpm/min for 20 seconds, then further mixed in a vacuum mixer having a pressure of 0.2 KPa under 1,000 rpm/min for 2 minutes, and finally mixed in a speed mixer under 2,000 rpm/min for 20 seconds. After the above stated mixing step, the resultant blend was either directly characterized or applied onto the surface of a substrate to produce a film sample.

The samples prepared in the Examples were characterized with the following technologies.

A. The SMP prepared in the above stated preparation example was characterized with Gel Permeation Chromatography (GPC) by using the following conditions and parameters: the GPC was conducted by using an Agilent 1200 model chromatograph equipped with two mixed D columns (7.8×300 mm) and an Agilent Refractive Index detector; the column temperature is 35° C., the temperature of the detector is 35° C., the flow rate is 1.0 mL/min, the mobile phase is tetrahydrofuran, the injection volume is 50 μL; the detection data was collected and analyzed with an Agilent GPC software based on a calibration curve obtained by using a PL Polystyrene Narrow standard (Part No.: 2010-0101) with molecular weights ranging from 316,500 to 316,580 g/mol.

It was measured that the SMP has a Mn of 21,662 and a Mw of 41,081, hence it can be calculated that it has a PDI of 1.90.

B. The mechanical properties of the samples prepared in Examples 1 to 8 according to ASTM D1708-06A. According to the procedures introduced in ASTM D1708-06A, the cured films of any examples were die-cut into a dog-bone-shaped specimen. The specimens were fixed on an Instron 5566 instrument and stretched at a constant speed of 50 mm/min The load at the yield point (if any), the maximum load carried by the specimen during the test, the load at rupture, and the elongation (extension between grips) at the moment of rupture were recorded. The shear strengths of the specimens were also measured on the Instron 5566 instrument with an adhesion area of 2.5 cm×2.5 cm. The measured results are also summarized in Table 2.

TABLE 2
The formulations for Examples 1 to 8

| | Ex 1 | Ex 2 | Ex 3 | Ex 4 | Ex 5 | Ex 6 | Ex 7 | Ex 8 |
|---|---|---|---|---|---|---|---|---|
| | (com.) | (com.) | (inv.) | (inv.) | (inv.) | (inv.) | (inv.) | (inv.) |
| Part A | | | | | | | | |
| SMP resin | 21 | 21 | 21 | 21 | 21 | 21 | 21 | 21 |
| TETA | | 1 | 1 | 1 | 1 | 1 | 1 | 1 |
| VTMS | 0.6 | 0.6 | 0.6 | 0.6 | 0.6 | 0.6 | 0.6 | 0.6 |
| XTCC-201 | | | | | | 10 | 10 | 10 |
| DINP | | | | | | 5 | 5 | 5 |
| Part B | | | | | | | | |
| D.E.R.383 | | 7 | 6 | 5 | 4 | 6 | 5 | 4 |
| KH560 | | | 1.34 | 2.68 | 4.03 | 1.34 | 2.68 | 4.03 |
| DMT | 0.4 | 0.4 | 0.4 | 0.4 | 0.4 | 0.4 | 0.4 | 0.4 |
| Results | | | | | | | | |
| Tensile | 0.8 | 2.7 | 5.3 | 2.8 | 3.9 | 2.6 | 2.8 | 2.6 |
| strength (MPa) | | | | | | | | |
| Elongation at | 75 | 215 | 157 | 208 | 174 | 125 | 106 | 98 |
| break (%) | | | | | | | | |
| 100% Modulus | NA | 1.2 | 2.6 | 1.3 | 1.8 | 2.2 | 2.7 | 2.5 |
| (MPa) | | | | | | | | |
| Shear strength | 0.1 | 2.2 | 2.8 | 3.6 | 8.1 | 4.6 | 4.9 | 5.1 |
| on galvanized | | | | | | | | |
| steel (MPa) | | | | | | | | |

The comparative example 2 does not comprise the compatibilizer and exhibits an adhesion strength of 2.7 MPa, which is quite similar with most of the SMP based adhesives commercially available in the market, and such an inferior adhesion cannot sufficiently meet the requirements of many customers in home appliances. As introduced in the foregoing paragraphs, the adhesive for home appliance needs to have an adhesion strength above 5.0 MPa while retaining an elongation at break of around 100%, so that thinner frame area can be achieved. Some industry assembly customers also frequently asked for SMP adhesives with higher adhesion strength on typical substrates such as gaivanized steel and stainless steel etc.

The comparison between the inventive examples and the comparative examples clearly shows that the introduction of epoxysilane compatibilizer can significantly increase the tensile strength (to a level of higher than 5.0 MPa), shear strength while retaining an elongation at break of around 100%, hence the SMP based products of the present disclosure can be made more competitive and differentiated in the market.

1. A curable composition, comprising
at least one silane modified polymer;
at least one epoxy resin terminated with epoxy group;
wherein the composition further comprises a hardening agent, and a compatibilizer which has at least one silane group and at least one epoxy terminal group.

2. The curable composition according to claim 1, wherein the curable composition is a two-component curable composition comprising a component A and a component B, wherein the silane modified polymer and the hardening agent are contained in the component A, and the epoxy resin and the compatibilizer are contained in the component B.

3. The curable composition according to claim 1, wherein the silane modified polymer is represented by formula I:
R¹ₘ(R²O)₍₃₋ₘ₎Si—R⁷-(polymeric main chain)-R⁸—SiR³ₙ(R⁴O)₍₃₋ₙ₎ Formula I
wherein the polymeric main chain is derived from a polyol, or derived from at least one polyisocyanate and at least one polyol, and is optionally functionalized with at least one —R⁹—SiR⁵ₛ(R⁶O)₍₃₋ₛ₎, each of R¹, and R⁶ independently represents a hydrogen atom or a C₁-C₆ alkyl group, each of m, n and s represents an integrate of 0, 1 or 2, each of R⁷, R⁸ and R⁹ independently represents a direct bond, —O—, a divalent (C₁ to C₆ alkylene) group, —O—(C₁ to C₆ alkylene) group, (C₁ to C₆ alkylene)-O— group, —O—(C₁ to C₆ alkylene)-O— group, —N(R_{N})—(C₁ to C₆ alkylene) group or —C(═O)—N(R_{N})—(C₁ to C₆ alkylene) group, wherein R_{N} represents a hydrogen atom or a C₁-C₆ alkyl group.

4. The curable composition according to claim 3, wherein the polymeric main chain is derived from polyether polyol, polyester polyol, or copolymer thereof.

5. The curable composition according to claim 1, wherein the compatibilizer is a compound represented by formula II, or a condensation oligomer/polymer thereof: 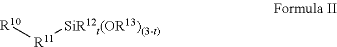
wherein R¹⁰ is selected a group consisting of 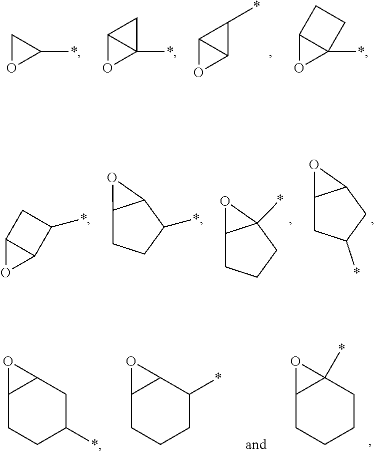
wherein * represents the linkage site,
R¹¹ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂[O—Si(C₁-C₆ alkyl)₂]ₓ-C₂-C₆ alkylene-(O—CH₂)—CH(OH)—CH₂—NH—C₂-C₆ alkylene, and —(CH₂—O)—C₂-C₆ alkylene-Si(C₁-C₆ alkoxy)₂-[O—Si(C₁-C₆ alkoxy)₂]ₓ-C₂-C₆ alkylene-(O—CH₂)—CH(OH)—CH₂—NH—C₂-C₆ alkylene,
wherein each of R¹² and R¹³ independently represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃,
t represents an integer of 0, 1 or 2, and x represents an integer of 1 to 100.

6. The curable composition according to claim 5, wherein the compatibilizer is a condensation oligomer or condensation polymer represented by formula III, 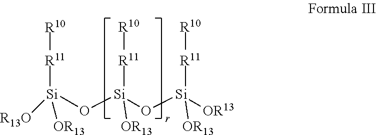
wherein R¹⁰ is selected a group consisting of 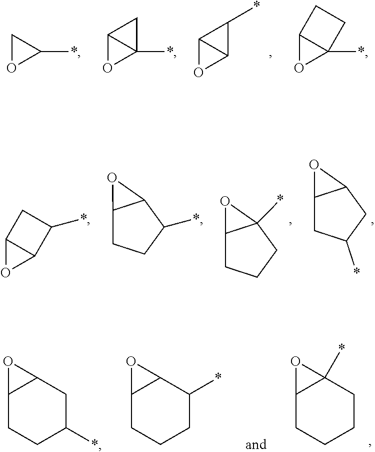
wherein * represents the linkage site,
R¹¹ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂-[O—Si(C₁-C₆ alkyl)₂]ₓ-C₂-C₆ alkylene-(O—CH₂)—CH(OH)—CH₂—NH—C₂-C₆ alkylene, and —(CH₂—O)—C₂-C₆ alkylene-Si(C₁-C₆ alkoxy)₂-[O—Si(C₁-C₆ alkoxy)₂]ₓ-C₂-C₆ alkylene-(O—CH₂)—CH(OH)—CH₂—NH—C₂-C₆ alkylene,
R¹³ represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₃, —Si(C₁-C₄ alkoxy)₃, —Si—{O—[Si(C₁-C₄alkoxy)₃]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄ alkoxy)₃]₃,
r represents an integer of 1 to 50, and x represents an integer of 1 to 100.

7. The curable composition according to claim 1, wherein the compatibilizer is selected from a group consisting of 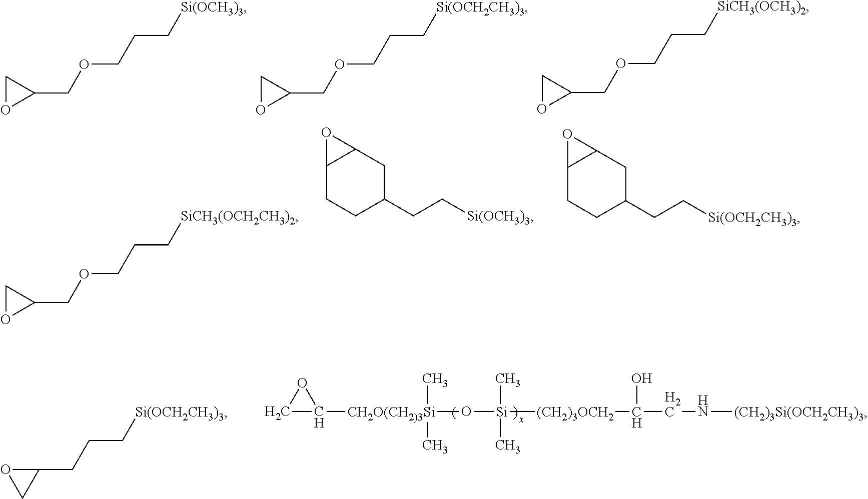
wherein x represents an integer of 1 to 100, 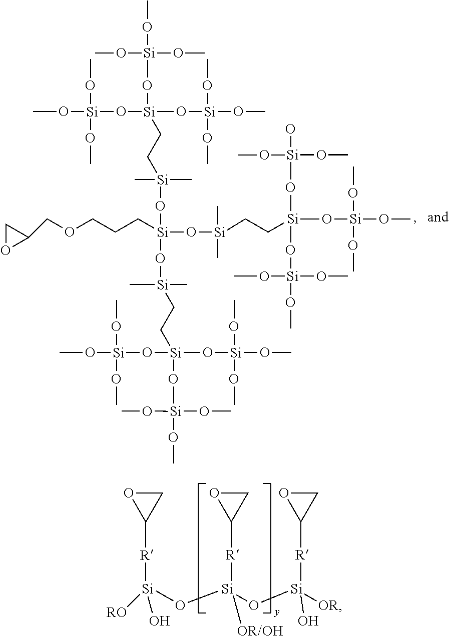
wherein R′ is selected from a group consisting of C₂-C₆ alkylene, —(CH₂—O)—C₂-C₆ alkylene, —C₂-C₆ alkylene-Si(C₁-C₆ alkyl)₂-C₂-C₆ alkylene, —(CH₂—O)—C₂-C₆ alkylene-Si(C₁-C₆ alkyl)₂-C₂-C₆ alkylene, —C₂-C₆ alkylene-Si(C₁-C₆ alkoxy)₂-C₂-C₆ alkylene, —(CH₂—O)—C₂-C₆ alkylene-Si(C₁-C₆ alkoxy)₂-C₂-C₆ alkylene, —(CH₂—O)—C₂-C₆ alkylene-Si(C₁-C₆ alkyl)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkoxy)₂-C₂-C₆ alkylene-(O—CH₂)—CH(OH)—CH₂—NH—C₂-C₆ alkylene, —(CH₂—O)—C₂-C₆ alkylene-Si(C₁-C₆ alkyl)₂[O—Si(C₁-C₆ alkyl)₂]ₓ-C₂-C₆ alkylene-(O—CH₂)—CH(OH)—CH₂—NH—C₂-C₆ alkylene, and —(CH₂—O)—C₂-C₆ alkylene-Si(C₁-C₆ alkoxy)₂-[O—Si(C₁-C₆ alkoxy)₂]ₓ-C₂-C₆ alkylene-(O—CH₂)—CH(OH)—CH₂—NH—C₂-C₆ alkylene, R represents a hydrogen atom or a C₁-C₆ alkyl group optionally substituted with C₁-C₆ alkyl group, C₁-C₆ alkoxy group, halogen atom, C₂-C₆ alkeny group, C₂-C₆ alkynyl group, —Si(C₁-C₄ alkyl)₄, —Si(C₁-C₄ alkoxy)₃, —Si—{O—[Si(C₁-C₄alkoxy)₄]₃, —(C₁-C₆)alkylene-Si(C₁-C₄ alkyl)₃, —(C₁-C₆)alkylene —Si(C₁-C₄ alkoxy)₃ or —(C₁-C₆)alkylene-Si—{O—[Si(C₁-C₄alkoxy)₃]₃, and y represents an integer of 1 to 50.

8. The curable composition according to claim 3, wherein the polymeric main chain is derived from a polyol, or derived from at least one polyisocyanate and at least one polyol,
the polyisocyanate is selected from the group consisting of C₄-C₁₂ aliphatic polyisocyanate comprising at least two isocyanate groups, C₆-C₁₅ cycloaliphatic or aromatic polyisocyanate comprising at least two isocyanate groups, C₇-C₁₅ araliphatic polyisocyanate comprising at least two isocyanate groups, and any combinations thereof, and
the polyol is selected from the group consisting of C₂-C₁₆ aliphatic polyhydric alcohols comprising at least two hydroxyl groups, C₆-C₁₅ cycloaliphatic or aromatic polyhydric alcohols comprising at least two hydroxyl groups, C₇-C₁₅ araliphatic polyhydric alcohols comprising at least two hydroxyl groups, polyester polyols having a molecular weight from 100 to 5,000 and an average hydroxyl functionality of 1.5 to 5.0, a polyether polyol having a molecular weight from 100 to 5,000 and an average hydroxyl functionality of 1.5 to 5.0, and combinations thereof.

9. The curable composition according to claim 1, wherein hardening agent is selected from the group consisting of aliphatic amine, alicyclic amine, aromatic amine, polyaminoamide, imidazole, dicyandiamides, epoxy-modified amines, Mannich-modified amines, Michael addition-modified amines and ketimines.

10. The curable composition according to claim 1, wherein the epoxy resin is selected from the group consisting of
glycidyl ethers of ethylene glycol, propylene glycol, butylene glycol, hexanediol, octanediol, polypropylene glycols, dimethylolcyclohexane, neopentyl glycol, dibromoneopentyl glycol, castor oil, trimethylolpropane, trimethylolethane, pentaerythritol, sorbitol or glycerol, or alkoxylated glycerol or alkoxylated trimethylolpropane;
glycidyl ethers of hydrogenated bisphenol A, F or A/F, or ring-hydrogenated liquid bisphenol A, F or A/F resins;
glycidyl ethers of bisphenol A resin, bisphenol AP resin, bisphenol F resin, bisphenol K resin, phenol-formaldehyde novolac resin, alkyl substituted phenol-formaldehyde resin, cresol-hydroxybenzaldehyde resin, dicyclopentadiene-phenol resin, dicyclopentadiene-substituted phenol resin, and combinations thereof.

11. The curable composition according to claim 1, wherein the silane modified polymer comprises 10 to 90 wt % of the curable composition, the epoxy resin comprises 5 to 70 wt % of the curable composition, the hardening agent comprises 1 to 8 wt % of the curable composition, and the compatibilizer comprises 1 to 20 wt % of the curable composition.

12. A method for applying the curable composition according to claim 1 onto a surface of a substrate, comprising the steps of
(1) combining the silane modified polymer, the epoxy resin, the hardening agent and the compatibilizer to form a precursor blend;
(2) applying the precursor blend onto a surface of a substrate; and
(3) curing the precursor blend, or allowing the precursor blend to cure.
